(19) United States
(12) Patent Application Publication
(10) Pub. No.: US 2008/0172263 A1
(43) Pub. Date: Jul. 17, 2008

(54) TRANSITIONING AN ORGANIZATION TO A SERVICE MANAGEMENT ORIENTED ORGANIZATION

(76) Inventor: Kirstin L. Heyman, Plymouth, MN (US)

Correspondence Address: HOFFMAN WARNICK LLC, 75 STATE ST, 14TH FLOOR, ALBANY, NY, 12207, US

(21) Appl. No.: 11/622,726

(22) Filed: Jan. 12, 2007

(51) Int. Cl. G06Q 90/00

(52) U.S. Cl. 705/7

(57) ABSTRACT

The present invention provides an approach to transition an IT organization such as a data center to a service management oriented organization. Specifically, under the present invention, data is gathered pertaining to how the organization is currently managed. Then a set of workshops is planned to provide education on IT service management, to establish service management nomenclature, to identify IT services that the organization is capable of providing internally, and to identify IT services that the organization is capable of providing externally. Thereafter, an IT services capabilities and strategy analysis is performed for the organization, predetermined quantity of the IT Services is decomposed into their constituent configuration item, and recommendations and a roadmap are developed for the organization to transition to the service management oriented organization.

### FIELD OF THE INVENTION

In general, the present invention relates to the transition of an organization such as a data center to a service management oriented organization. Specifically, the present invention relates to the defining of an IT service catalogue or the like pursuant to the application of process framework to an organization.

### BACKGROUND OF THE INVENTION

A recent trend in the Information Technology (IT) arena has data centers moving towards a centralized and shared services structure whereby all related Lines of Businesses (LOBs) will know need to use a common data center. This presents various problems. For example, the data center manager will have to know what services, skills, capabilities he need to be able to provide to his new-found clients.

While there are several different ways to approach this problem, there is no single, complete, industry accepted approach. These issues are compounded by a ‘hot trend’ in the IT industry known as is the ITIL process framework (recently incorporated in ISO20000) (ITIL is a trademark of Pink Elephant Nederland B.V. LTD LIAB CO of Voorberg Netherlands in the United Sattes and/or other countries). That set for a standard or service managemen-orientation for IT organizations such as data centers. One requirement of the framework is to define an IT service catalogue for the organization. Unfortunately, neither the framework itself nor any other party has defined how the framework should be adapted and applied to an organization. As such, one way to tackle this problem is using ITIL as the framework.

### SUMMARY OF THE INVENTION

In general, the present invention provides an approach to transition an IT organization such as a data center to a service management oriented organization. In part, this will include applying a framework such as the ITIL process framework to define a service catalogue for the entity. Specifically, under the present invention, data is gathered pertaining to how the organization is currently managed. Then a set of workshops is planned to provide education on IT service management, to establish service management nomenclature, to identify IT services that the organization is capable of providing internally, and to identify IT services that the organization is capable of providing externally. Thereafter, an IT services capabilities and strategy analysis is performed for the organization, predetermined quantity of the IT Services is decomposed into their constituent configuration item, and recommendations and a roadmap are developed for the organization to transition to the service management oriented organization.

A first aspect of the present invention provides a method for defining an Information Technology (IT) service catalogue for an organization, comprising: gathering data pertaining to current management of the organization; planning a set of workshops to identify IT services that the organization is capable of providing; determining a quality with which the IT services are being provided by the organization; determining whether the organization is failing to provided any needed IT services; decomposing a predetermined quantity of the IT services into a their constituent configuration items; defining the IT service catalogue based on the identified IT services; and if the organization is failing to provide any needed IT services, developing recommendations for providing the needed IT services.

A second aspect of the present invention provides a method for transitioning an organization to a service management oriented organization, comprising: gathering data pertaining to how the organization is currently managed; planning a set of workshops to provide education on IT service management, to establish service management nomenclature, to identify IT services that the organization is capable of providing internally, and to identify IT services that the organization is capable of providing externally; conducting an IT services capabilities and strategy analysis for the organization; decomposing a predetermined quantity of the IT Services into their constituent configuration items; and developing recommendations and a roadmap for the organization to transition to the service management oriented organization.

A third aspect of the present invention provides a system for transitioning an organization to a service management oriented organization, comprising: a data collection module for gathering data pertaining to how the organization is currently managed; a planning module for planning a set of workshops to provide education on IT service management, to establish service management nomenclature, to identify IT services that the organization is capable of providing internally, and to identify IT services that the organization is capable of providing externally; an analysis module for conducting an IT services capabilities and strategy analysis for the organization; a service module for decomposing a predetermined quantity of the IT Services into their constituent configuration items; and a roadmap module for developing recommendations and a roadmap for the organization to transition to the service management oriented organization.

A fourth aspect of the present invention provides a program product stored on a computer readable medium for transitioning an organization to a service management oriented organization, the computer readable medium comprising program code for causing a computer system to: gather data pertaining to how the organization is currently managed; plan a set of workshops to provide education on IT service management, to establish service management nomenclature, to identify IT services that the organization is capable of providing internally, and to identify IT services that the organization is capable of providing externally; conduct an IT services capabilities and strategy analysis for the organization; decompose a predetermined quantity of the IT Services into their constituent configuration items; and develop recommendations and a roadmap for the organization to transition to the service management oriented organization.

A fifth aspect of the present invention provides a method for deploying a system for transitioning an organization to a service management oriented organization, comprising: providing a computer infrastructure being operable to: gather data pertaining to how the organization is currently managed; plan a set of workshops to provide education on IT service management, to establish service management nomenclature, to identify IT services that the organization is capable of providing internally, and to identify IT services that the organization is capable of providing externally; conduct an IT services capabilities and strategy analysis for the organization; decompose a predetermined quantity of the IT Services into their constituent configuration items; and develop recommendations and a roadmap for the organization to transition to the service management oriented organization.

A sixth aspect of the present invention provides computer software embodied in a propagated signal for transitioning an organization to a service management oriented organization, the computer software comprising instructions for causing a computer system to: gather data pertaining to how the organization is currently managed; plan a set of workshops to provide education on IT service management, to establish service management nomenclature, to identify IT services that the organization is capable of providing internally, and to identify IT services that the organization is capable of providing externally; conduct an IT services capabilities and strategy analysis for the organization; decompose a predetermined quantity of the IT Services into their constituent configuration items; and develop recommendations and a roadmap for the organization to transition to the service management oriented organization.

A seventh aspect of the present invention provides a data processing system for transitioning an organization to a service management oriented organization, comprising: a processor, a bus coupled to the processor, a memory medium coupled to the bus, the memory medium comprising instructions, which when executed by the processor, cause the data processing system to: gather data pertaining to how the organization is currently managed; plan a set of workshops to provide education on IT service management, to establish service management nomenclature, to identify IT services that the organization is capable of providing internally, and to identify IT services that the organization is capable of providing externally; conduct an IT services capabilities and strategy analysis for the organization; decompose a predetermined quantity of the IT Services into their constituent configuration items; and develop recommendations and a roadmap for the organization to transition to the service management oriented organization.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a graphical illustration of an analysis according to the present invention.

FIG. 2 shows illustrative services and how they can cross an illustrative organization according to the present invention.

FIG. 3 shows a system for transitioning an organization to a service management oriented organization according to the present invention.

FIG. 4 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections:

I. General Description

II. Computerized Implementation

### I. General Description

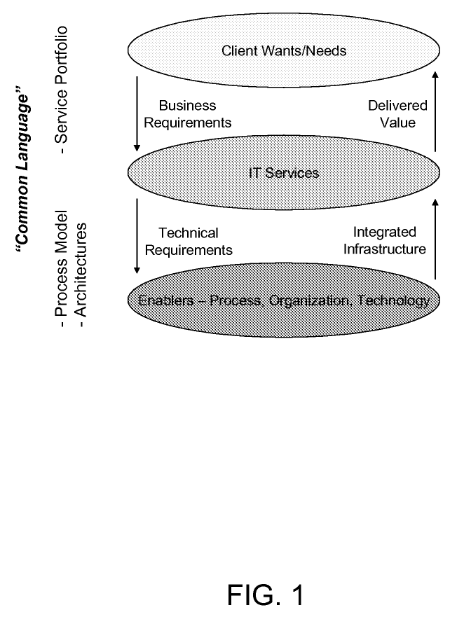

As indicated above, the present invention provides an approach to transition an IT organization such as a data center to a service management oriented organization. In part, this will include applying a framework such as the ITIL process framework to define a service catalogue for the entity. Specifically, under the present invention, data is gathered pertaining to how the organization is currently managed. Then a set of workshops is planned to provide education on IT service management, to establish service management nomenclature, to identify IT services that the organization is capable of providing internally, and to identify IT services that the organization is capable of providing externally. Thereafter, an IT services capabilities and strategy analysis is performed for the organization. A graphical illustration of an analysis is shown in FIG. 1. As can be seen the analysis is includes various relationships between client needs, IT services provided, and enablers. Regardless, Among other things, the includes an analysis of: what IT services the organization is currently providing, what IT services the organization is capable of providing, what IT services the organization should providing, what IT services the organization should be providing but is currently failing to provide (e.g., a gap analysis). Thereafter, a predetermined quantity (e.g., two) of the IT Services is decomposed into their constituent IT configuration items (i.e. applications and software (including OSs), network (routers, hubs, switches), hardware (PCs, servers etc.)), and recommendations and a roadmap are developed for the organization to transition to the service management oriented organization. Along these lines, a catalogue of the IT services is defined and produced.

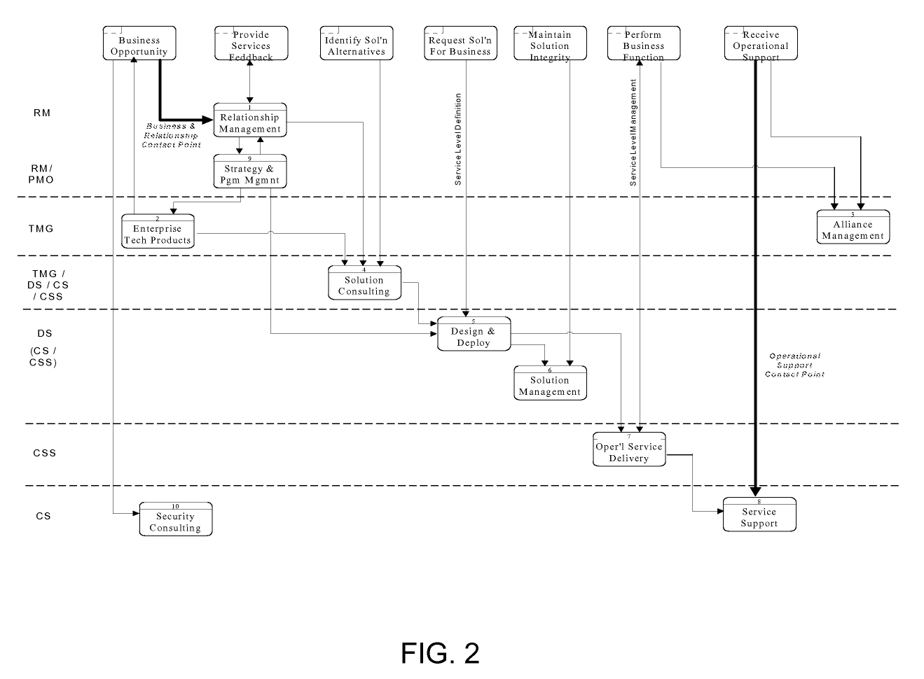

Referring now to FIG. 2 an illustration of a situation where ten services are identified and how those services cross the IT organization (acronyms on the left of FIG. 1 represent hypothetical IT department names). Decomposing one service drills the IT services down into IT components (such as applications, network, and servers).

### II. Computerized Implementation

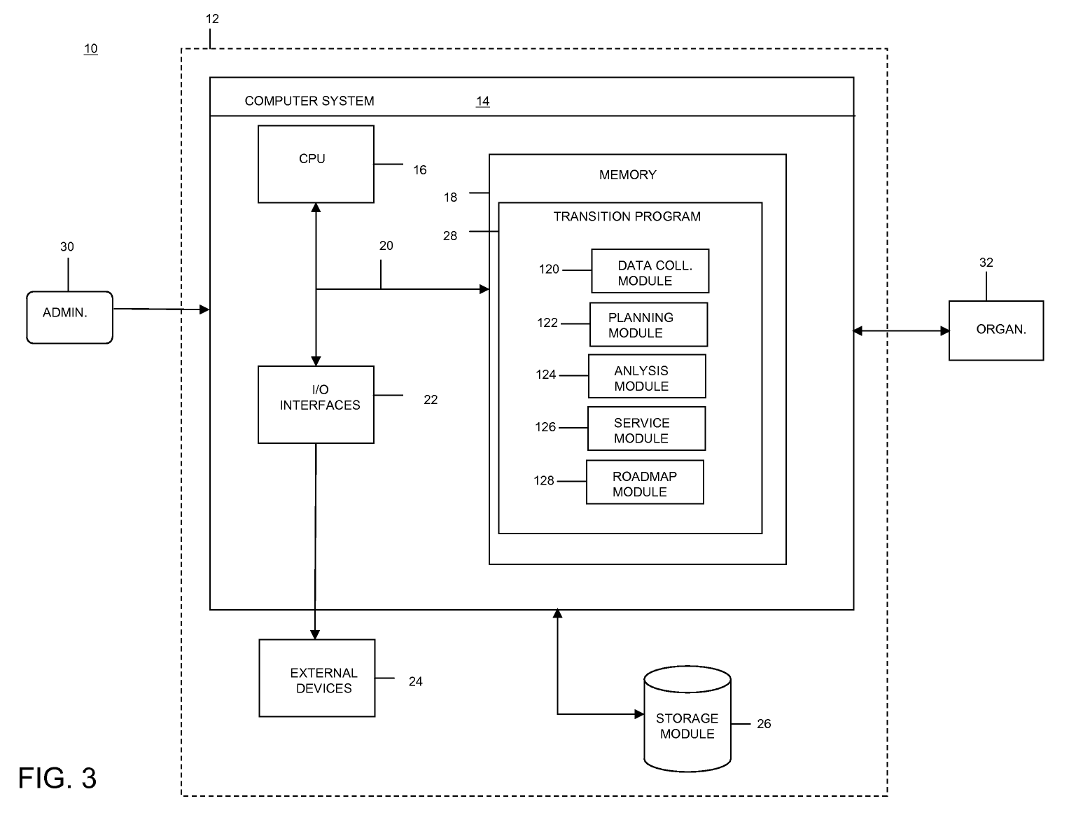

Referring now to FIG. 3, a detailed diagram of a computerized implementation 10 of the present invention is shown. As depicted, implementation 10 includes computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of implementation 10 could be deployed, managed, serviced, etc. by a service provider who offers to implement, deploy, and/or perform the functions of the present invention for others.

As shown, computer system 14 includes a processing unit 16, a memory 18, a bus 20, and input/output (I/O) interfaces 22. Further, computer system 14 is shown in communication with external I/O devices/resources 24 and storage system 16. In general, processing unit 16 executes computer program code, such as transition program 28, which is stored in memory 18 and/or storage system 16. While executing computer program code, processing unit 16 can read and/or write data to/from memory 18, storage system 16, and/or I/O interfaces 22. Bus 20 provides a communication link between each of the components in computer system 14. External devices 24 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the process(es) of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 16 may comprise a single processing unit, or be distributed across one or more processing units in one or more locations, e.g., on a client and server. Similarly, memory 18 and/or storage system 16 can comprise any combination of various types of data storage and/or transmission media that reside at one or more physical locations. Further, I/O interfaces 22 can comprise any system for exchanging information with one or more external device 24. Still further, it is understood that one or more additional components (e.g., system software, math co-processing unit, etc.) not shown in FIG. 3 can be included in computer system 14. However, if computer system 14 comprises a handheld device or the like, it is understood that one or more external devices 24 (e.g., a display) and/or storage system 16 could be contained within computer system 14, not externally as shown.

Storage system 16 can be any type of system (e.g., a database) capable of providing storage for information under the present invention. To this extent, storage system 16 could include one or more storage devices, such as a magnetic disk drive or an optical disk drive. In another embodiment, storage system 16 includes data distributed across, for example, a local area network (LAN), wide area network (WAN) or a storage area network (SAN) (not shown). In addition, although not shown, additional components, such as cache memory, communication systems, system software, etc., may be incorporated into computer system 14. It should be understood computer system could be any combination of human, hardware and/or software. It is shown as such to illustrate the functions as described herein.

Shown in memory 18 of computer system 14 is transition program 28, which facilitates the functions as described herein. As depicted, transition program 28 includes data collection module 120, planning module 122, analysis module 124, service module 126, and roadmap module 130. It should be understood that this configuration of functionality is intended to be illustrative only, and that identical or similar functionality could be provided with a different configuration of systems. In an illustrative embodiment, organization 32 is a data center or the like. However, it should be appreciated that the teachings herein could be applied to any type of IT organization.

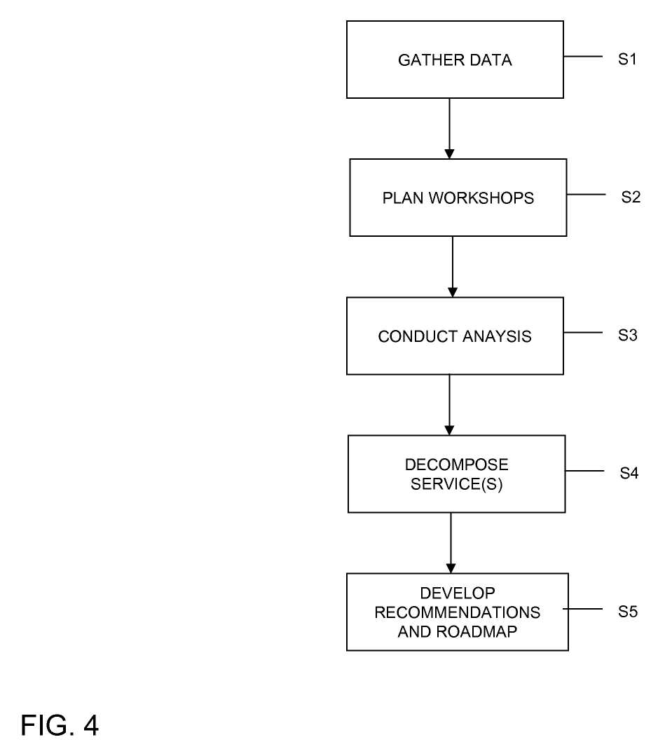

The present invention will now be described with reference to FIGS. 3 and 4 collectively. In general, in step S1, data collection module 120 is leveraged by administrator/operator 30 to gather data pertaining to how the organization is currently managed. This data collection can include a review of existing documentation (IT process descriptions, process metrics, SLAs, SLOs, customer satisfaction results, IT strategy, business strategy, IT roles and responsibilities, etc.), interviews, etc. In step S2, planning module 122 will be leveraged to plan, prepare, and conduct and carry out a set of workshops. In a typical embodiment, the set of workshops includes the following: (1) a process framework workshop to provide education to the organization on the process framework; (2) a terminology workshop to establish/define nomenclature applicable to the process framework; (3) an external service workshop to identify the IT services external to the organization (e.g., that it provides to clients such as connected LOBs); (4) an internal service workshop to identify the IT services internal to the organization; and (5) a road-map workshop to define a plan for applying the process framework to the framework by defining the IT service catalogue.

In step S3, analysis module 124 will be to conduct an IT services capabilities and strategy analysis. Among other things, this analysis can include an analysis of at least one of the following: (1) what IT services (internal and/or external) organization 32 is currently providing to its LOBs (and optionally how well they are being provided); (2) what IT services organization 32 is capable of providing, what IT services organization 32 should be providing (but may not currently be providing). This analysis can be conducted with direct contact with organization 32 personnel and/or clients or from a capabilities and industry perspective without such direct contact). One purpose of the analysis is to understand current Service Level Management processes of organization 32, as well as to perform a “gap” analysis for things organization is missing.

Regardless, in the S4, service module 126 will a predetermined quantity of selected IT Services into their constituent configuration items (CI's). In a typical embodiment two IT services are decomposed. However, any quantity could actually be decomposed based on a cost benefit analysis. In step S6, roadmap module 128 is leveraged to document conclusions and develop. That is, recommendations and a roadmap are developed for the organization to transition to a service management oriented organization. In this illustrative embodiment, this can include defining and producing an IT service catalogue for organization 32.

While shown and described herein as a method and system for transitioning an organization to an IT service management oriented organization, it is understood that the invention further provides various alternative embodiments. For example, in one embodiment, the invention provides a computer-readable/useable medium that includes computer program code to enable a computer infrastructure to apply brokering methods to operational support characteristics. To this extent, the computer-readable/useable medium includes program code that implements the process(es) of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 18 (FIG. 3) and/or storage system 16 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to transition an organization to an IT service management oriented organization. In this case, the service provider can create, maintain, support, etc., a computer infrastructure, such as computer infrastructure 12 (FIG. 3) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for transitioning an organization to an IT service management oriented organization. In this case, a computer infrastructure, such as computer infrastructure 12 (FIG. 3), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 14 (FIG. 3), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for defining an Information Technology (IT) service catalogue for an organization, comprising:
gathering data pertaining to current management of the organization;
planning a set of workshops to identify IT services that the organization is capable of providing;
determining a quality with which the IT services are being provided by the organization;
determining whether the organization is failing to provided any needed IT services;
decomposing a predetermined quantity of the IT services into a their constituent configuration items;
defining the IT service catalogue based on the identified IT services; and
if the organization is failing to provide any needed IT services, developing recommendations for providing the needed IT services.

2. The method of claim 1, the organization being a data center, and the IT service catalogue being defined pursuant to a process framework applicable to the data center.

3. The method of claim 2, the identified IT services comprising IT services internal to the organization and IT services external to the organization.

4. The method of claim 3, the gathering comprising reviewing existing documentation for the organization, and conducting interviews.

5. The method of claim 4, the set of workshops comprising:
an external service workshop to identify the IT services external to the organization; and
an internal service workshop to identify the IT services internal to the organization.

6. The method of claim 5, further comprising:
planning a process framework workshop to provide education to the organization on the process framework;
planning a terminology workshop to define terminology applicable to the process framework; and
planning a road-map workshop to define a plan for applying the process framework to the framework by defining the IT service catalogue.

7. A method for transitioning an organization to a service management oriented organization, comprising:
gathering data pertaining to how the organization is currently managed;
planning a set of workshops to provide education on IT service management, to establish service management nomenclature, to identify IT services that the organization is capable of providing internally, and to identify IT services that the organization is capable of providing externally;
conducting an IT services capabilities and strategy analysis for the organization;
decomposing a predetermined quantity of the IT Services into their constituent configuration items; and
developing recommendations and a roadmap for the organization to transition to the service management oriented organization.

8. The method of claim 7, the gathering comprising reviewing existing documentation, and conducting interviews.

9. The method of claim 7, the conducting comprising analyzing what IT services the organization is currently providing, what IT services the organization is capable of providing, what IT services the organization should providing, what IT services the organization should be providing but is currently failing to provide.

10. The method of claim 7, the transition being pursuant to a process framework being applied to the organization.

11. The method of claim 7, the organization being a data center.

12. The method of claim 7, the developing further comprising defining an IT service catalogue for the organization.

13. A system for transitioning an organization to a service management oriented organization, comprising:
a data collection module for gathering data pertaining to how the organization is currently managed;
a planning module for planning a set of workshops to provide education on IT service management, to establish service management nomenclature, to identify IT services that the organization is capable of providing internally, and to identify IT services that the organization is capable of providing externally;
an analysis module for conducting an IT services capabilities and strategy analysis for the organization;
a service module for decomposing a predetermined quantity of the IT Services into their constituent configuration items; and
a roadmap module for developing recommendations and a roadmap for the organization to transition to the service management oriented organization.

14. The system of claim 13, the IT services capabilities and strategy analysis comprising an analysis of: what IT services the organization is currently providing, what IT services the organization is capable of providing, what IT services the organization should providing, what IT services the organization should be providing but is currently failing to provide.

15. The system of claim 13, the transition of the organization to the service management oriented organization to being pursuant to a process framework being applied to the organization.

16. The system of claim 13, the organization being a data center.

17. The system of claim 13, the roadmap module further defining an IT service catalogue for the organization pursuant to the transition.

18. A program product stored on a computer readable medium for transitioning an organization to a service management oriented organization, the computer readable medium comprising program code for causing a computer system to:
gather data pertaining to how the organization is currently managed;
plan a set of workshops to provide education on IT service management, to establish service management nomenclature, to identify IT services that the organization is capable of providing internally, and to identify IT services that the organization is capable of providing externally;
conduct an IT services capabilities and strategy analysis for the organization;
decompose a predetermined quantity of the IT Services into their constituent configuration items; and
develop recommendations and a roadmap for the organization to transition to the service management oriented organization.

19. The program product of claim 18, the IT services capabilities and strategy analysis comprising an analysis of: what IT services the organization is currently providing, what IT services the organization is capable of providing, what IT services the organization should providing, what IT services the organization should be providing but is currently failing to provide.

20. The program product of claim 18, the transition being pursuant to a process framework being applied to the organization.

21. The program product of claim 18, the organization being a data center.

22. The program product of claim 18, the computer readable medium comprising program code for causing the computer system to defining an IT service catalogue for the organization pursuant to the transition.

23. A method for deploying a system for transitioning an organization to a service management oriented organization, comprising:
providing a computer infrastructure being operable to:
gather data pertaining to how the organization is currently managed;
plan a set of workshops to provide education on IT service management, to establish service management nomenclature, to identify IT services that the organization is capable of providing internally, and to identify IT services that the organization is capable of providing externally;
conduct an IT services capabilities and strategy analysis for the organization;
decompose a predetermined quantity of the IT Services into their constituent configuration items; and
develop recommendations and a roadmap for the organization to transition to the service management oriented organization.
